(19) United States
(12) Patent Application Publication
(10) Pub. No.: US 2026/0170678 A1
(43) Pub. Date: Jun. 18, 2026

(54) OBJECT LOCALIZATION SYSTEM AND METHOD FOR OBJECT LOCALIZATION

(71) Applicant: LITE-ON TECHNOLOGY CORPORATION, TAIPEI CITY (TW)

(72) Inventors: Chih-Yuan CHUANG, TAIPEI CITY (TW); Yen-Chun CHEN, TAIPEI CITY (TW); Chuen Ning HSU, TAIPEI CITY (TW); Jiun-Shiung CHEN, TAIPEI CITY (TW)

(21) Appl. No.: 19/291,768

(22) Filed: Aug. 6, 2025

Related U.S. Application Data
(60) Provisional application No. 63/735,451, filed on Dec. 18, 2024.

(51) Int. Cl. G06T 7/70; G06T 3/40; G06T 7/12; G06T 7/13; G06T 7/80; G06V 10/46

(52) U.S. Cl. CPC G06T 7/70; G06T 3/40; G06T 7/12; G06T 7/13; G06T 7/80; G06V 10/46; G06T 2207/30244

(57) ABSTRACT

An object localization system including a processing device, a perception camera, and a memory is provided. The perception camera couples to the processing device and is mounted on a self-propelled apparatus, wherein the perception camera is configured to generate an image frame. The processing device executes a computer-readable code included in the memory to: generate a mask of an entity within the image frame and determine a category of the entity using an instance segmentation model; project the mask onto a bird-eye-view (BEV) plane of a global coordinate system to generate a projected mask; identify a front-facing edge of the projected mask relative to the perception camera; determine a reference location corresponding to the front-facing edge; and generate a measured location of the entity on the BEV plane based on the reference location and the category of the entity.

### CROSS REFERENCE TO RELATED APPLICATIONS

This application claims the benefit of U.S. Provisional Application No. 63/735,451, filed on Dec. 18, 2024, the entirety of which is incorporated by reference herein.

### BACKGROUND OF THE INVENTION

### Field of the Invention

The present invention relates to image analysis techniques, particularly to an object localization system and a method for object localization.

### Description of the Related Art

Bounding box representation is a common method for processors on a vehicle to determine the locations or motions of the surrounding entities. In current practice, the processors may select a particular point of the bounding box corresponding to the entity in an image to determine the location of the entity in the physical space. Since discrepancies may occur between cameras capturing images of the same entity, inconsistencies may arise between the locations determined from images acquired by different cameras. As a result, the accuracy of the entity's location is reduced, which can lead to increased collision risks.

Accordingly, there is a need for an object localization system and a method for object localization addressing the above-mentioned challenges,

### BRIEF SUMMARY OF THE INVENTION

An embodiment of the present invention provides an object localization system, comprising a processing device, a perception camera, and a memory. The perception camera is coupled to the processing device and mounted on a self-propelled apparatus, wherein the perception camera is configured to generate an image frame. The memory comprises a computer-readable code executable by the processing device.

The processing device executes the computer-readable code to generate a mask of an entity within the image frame and determine a category of the entity by using an instance segmentation model. The processing device further projects the mask onto a bird-eye-view (BEV) plane of a global coordinate system associated with the self-propelled apparatus to generate a projected mask. The processing device identifies a front-facing edge of the projected mask relative to the perception camera on the BEV plane. The processing device further determines a reference location corresponding to the front-facing edge, wherein the reference location comprises at least one set of coordinates representing the entity on the BEV plane. The processing device further generates a measured location of the entity on the BEV plane based on the reference location and the category of the entity.

In addition, the memory further stores a historical trajectory including a previous location of the entity on the BEV plane, and wherein the computer-readable code is executable by the processing device to generate a predicted location on the BEV plane based on the historical trajectory. The processing device further calculates a distance between the measured location and the predicted location. The processing device further associates the measured location with the predicted location to obtain an updated location of the entity on the BEV plane in response to the distance between the measured location and the predicted location satisfying a second predefined criterion.

Another embodiment of the present invention provides a method for object localization, executed by a processing device, wherein the method comprises generating an image frame by a perception camera mounted on a self-propelled apparatus. The method further comprises generating a mask of an entity within the image frame and determining a category of the entity using an instance segmentation model. The method further comprises projecting the mask onto a bird-eye-view (BEV) plane of a global coordinate system associated with the self-propelled apparatus to generate a projected mask. The method further comprises identifying a front-facing edge of the projected mask relative to the perception camera on the BEV plane. The method further comprises determining a reference location corresponding to the front-facing edge, wherein the reference location comprises at least one set of coordinates representing the entity on the BEV plane. The method further comprises generating a measured location of the entity on the BEV plane based on the reference location and the category of the entity.

### BRIEF DESCRIPTION OF THE DRAWINGS

The present invention can be more fully understood by reading the subsequent detailed description and examples with references made to the accompanying drawings, wherein:

FIG. 1 shows a scenario of a self-propelled apparatus measuring surrounding entities according to embodiments of the present disclosure.

FIG. 2 shows a block diagram of a processing device for object localization according to embodiments of the present disclosure.

FIGS. 3 and 4 show methods for object localization according to embodiments of the present disclosure.

FIGS. 5A to 5D show a procedure for obtaining the front-facing edge of an entity according to embodiments of the present disclosure.

FIGS. 6A and 6B show a procedure for obtaining a set of frontal pixels of the front-facing edge according to embodiments of the present disclosure.

FIGS. 7A to 7E show a procedure for obtaining an optimum rectangle according to embodiments of the present disclosure.

FIGS. 8A to 8C show a procedure for generating a resized rectangle according to embodiments of the present disclosure.

FIG. 9 shows a method for tracking and predicting entity locations according to embodiments of the present disclosure.

FIGS. 10A and 10B show historical trajectories of the entity with different predicted locations according to embodiments of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

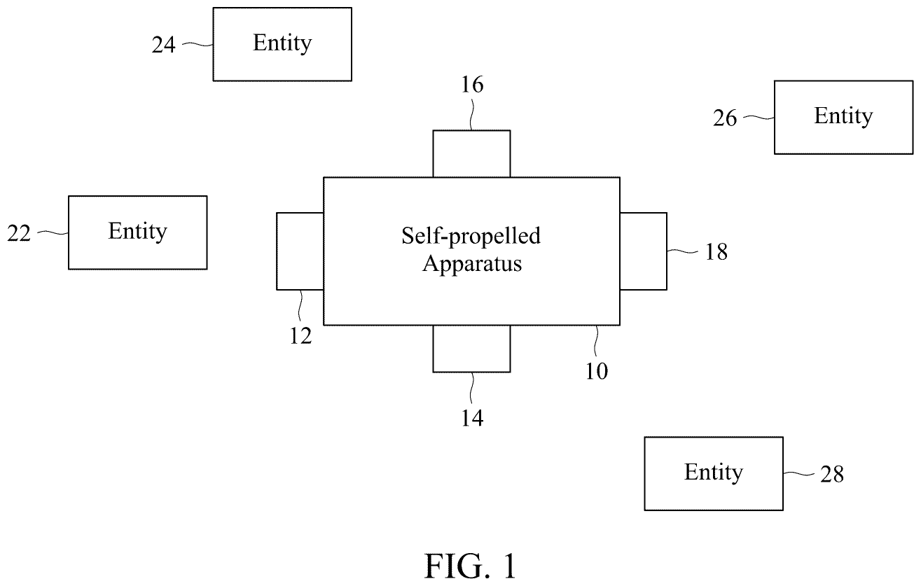

FIG. 1 shows a scenario in which a self-propelled apparatus 10 measures surrounding entities 22, 24, 26, and 28 according to embodiments of the present disclosure. Four perception cameras 12, 14, 16, and 18 are mounted on the self-propelled apparatus 10 to generate image frames covering surrounding environment of the entities 22, 24, 26, and 28. As shown in FIG. 1, the perception cameras 12, 14, 16, and 18 are mounted on the front, left, right, and rear sides of the self-propelled apparatus 10, respectively. In other embodiments, a different number of cameras may be mounted on the self-propelled apparatus 10. Additionally, the cameras may be mounted in different positions than those shown in FIG. 1.

The self-propelled apparatus 10 may be a self-driving vehicle, and the perception cameras 12, 14, 16, and 18 may be fish-eye (or fisheye) cameras mounted on the self-driving vehicle. Each of the perception cameras 12, 14, 16, and 18 generates an image frame containing one or more of the entities selected from 22, 24, 26, and 28, and outputs the image frames to the processing device in the self-propelled apparatus 10 for performing object localization. Since the perception cameras 12, 14, 16, and 18, which in this embodiment are implemented as fish-eye cameras, are configured to generate wide-view images, image frames generated by different perception cameras may include the same entities. For example, image frames generated by perception cameras 12 and 16 may both include the entity 24, while image frames generated by perception cameras 16 and 18 may both include the entity 26. By utilizing image frames having an overlapping field of view, the same entity can be captured by different cameras, thereby improving the accuracy of object localization.

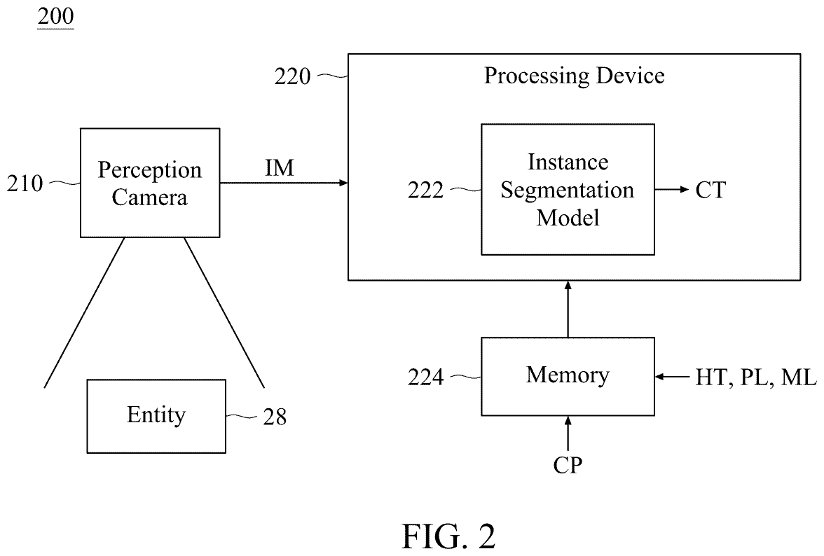

FIG. 2 shows a block diagram 200 of a processing device 220 for object localization according to embodiments of the present disclosure. A perception camera 210, which is mounted on the self-propelled apparatus 10, captures the entity 28 and generates an image frame IM. Subsequently, the image frame IM is output to the processing device 220 for object localization, as further described below. The processing device 220 includes an instance segmentation model 222 for determining a category CT of the entity 28. A memory 224 is configured to store computer-readable code executable by the processing device 220. Additionally, the memory 224 stores a historical trajectory HT, predicted locations PL, and measured locations ML for trajectory prediction of an entity.

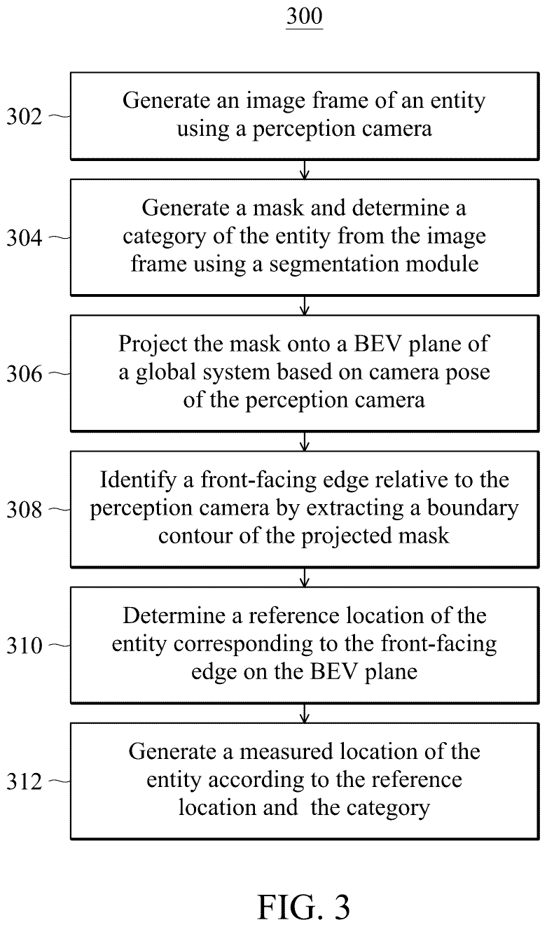

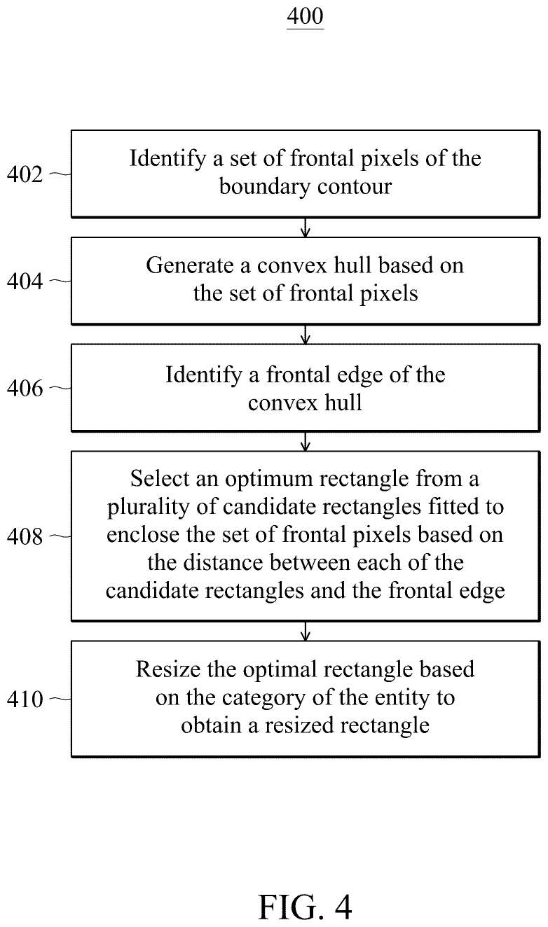

The memory 224 is further configured to store a camera pose CP for projecting the image frame IM onto a bird-eye-view (BEV) plane. The camera pose CP includes extrinsic and intrinsic parameters of the perception cameras 12, 14, 16, and 18 relative to a global coordinate system. The extrinsic parameters include height information (e.g., the distance between the perception camera and the ground), a horizontal position, and orientation information (e.g., the heading direction of the self-propelled apparatus). When executing the computer-readable code, the processing device 220 performs the object localization for the entity 28, as further described with reference to FIGS. 3 and 4.

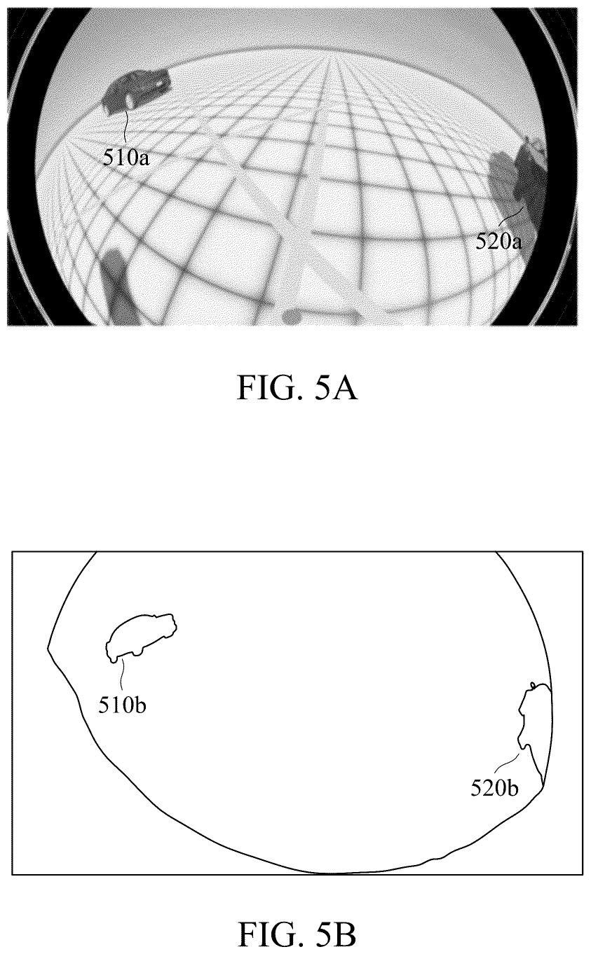

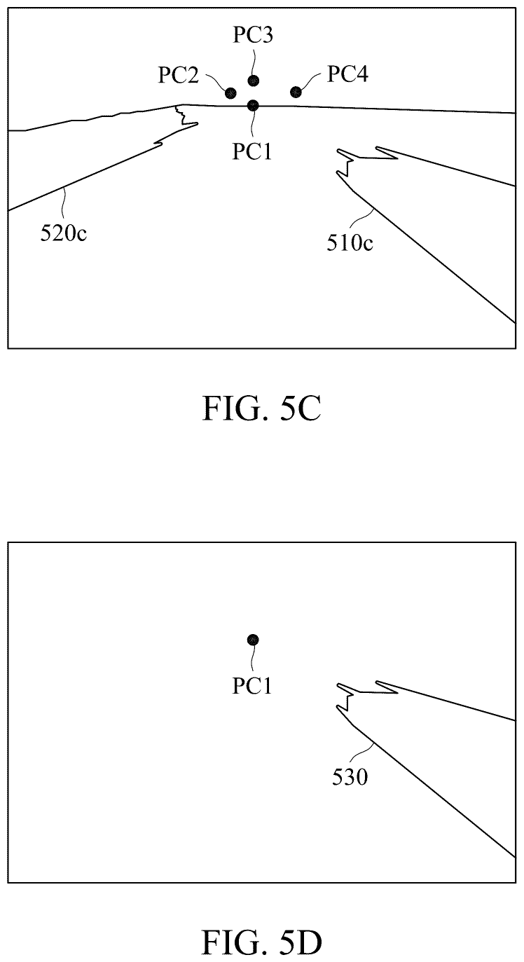

FIGS. 3 and 4 show methods 300 and 400 for object localization according to embodiments of the present disclosure. FIG. 3 shows the method 300, which represents the overall procedure performed by the processing device 220 for object localization. At step 302, each of the perception cameras 12, 14, 16, and 18 generates an image frame IM of at least one of the entities 22, 24, 26, and 28. At step 304, the image frame IM is provided to the processing device 220 to determine the category CT of the entities 22, 24, 26, or 28 included in the image frame IM. By using the instance segmentation model 222, the processing device 220 generates a mask for each of the included entities 22, 24, 26, and 28, and determines the category CT based on the masks (see FIG. 5B). At step 306, the processing device 220 projects the masks of the entities 22, 24, 26, and 28 onto the BEV plane based on the camera pose CP stored in the memory 224 (see FIG. 5C).

After the masks are projected, at step 308, the processing device 220 identifies a front-facing edge of each of the projected masks relative to the perception cameras 12, 14, 16, and 18 (see FIG. 5D). The front-facing edge of the projected mask is identified by extracting a boundary contour of the projected mask. Subsequently, at step 310, the processing device 220 determines a reference location of the entities 22, 24, 26, or 28 corresponding to the front-facing edge on the BEV plane. At step 312, the processing device 220 generates the measured location ML of the entities 22, 24, 26, or 28 based on the reference location and the category CT.

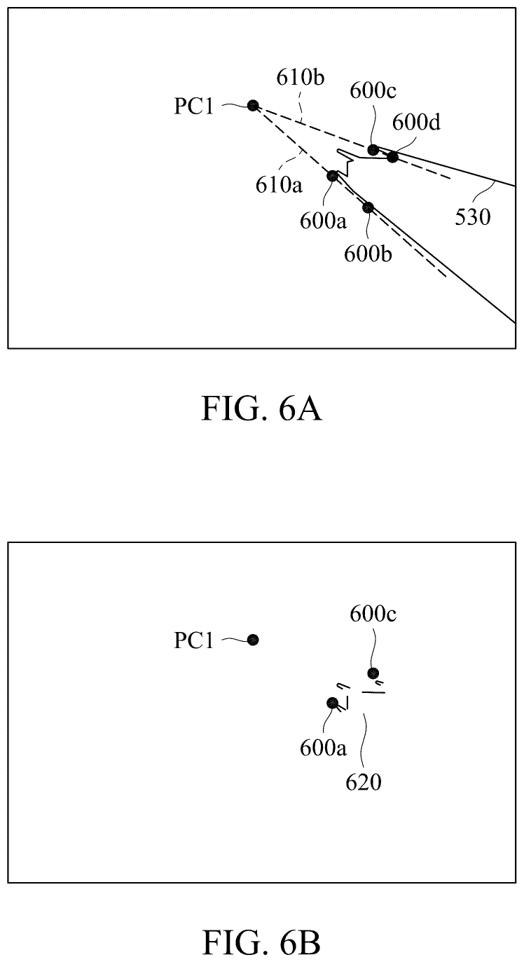

FIG. 4 shows a detailed procedure of steps 310 and 312, as method 400. At step 402, the processing device 220 identifies a set of frontal pixels from the boundary contour. Then, at step 404, the processing device 220 generates a convex hull encompassing the set of frontal pixels. At step 406, the processing device 220 identifies a frontal edge of the convex hull using a similar method as that used to identify the set of frontal pixels (described below with reference to FIGS. 6A and 6B). At step 408, the processing device 220 generates a plurality of candidate rectangles that are fitted to enclose the set of frontal pixels, and selects one of the candidate rectangles as an optimum rectangle to determine the reference location of the entity. At step 410, the processing device 220 resizes the optimum rectangle based on the category CT to generate a resized rectangle. Based on the resized rectangle, the processing device 220 determines the measured location ML of the entity.

Using methods 300 and 400, the processing device 220 of the present disclosure may identify the categories, orientations, and distances of the entities 22, 24, 26, and 28 relative to the self-propelled apparatus 10. The processing device 220 uses instance segmentation instead of the conventional bounding box method. This improves the accuracy of object localization by measuring the entities based on their boundary contours instead of a specific point of the boundary box. Additionally, methods 300 and 400 involve simple image processing, which requires fewer computational resources and lower complexity compared with a fully end-to-end deep learning method.

A detailed description is made concerning FIGS. 5A to 8C, which illustrate each step of methods 300 and 400.

FIGS. 5A to 5D show a procedure for identifying a front-facing edge 530 of the entity 510a according to embodiments of the present disclosure. FIG. 5A shows an image frame IM captured by a perception camera mounted on a vehicle, which contains entities 510a and 520a (step 302). Subsequently, in FIG. 5B, the image frame IM is provided to the instance segmentation model 222 to generate masks 510b and 520b corresponding to entities 510a and 520a, respectively. After the masks 510b and 520b are generated, the instance segmentation model 222 identifies the category CT of each of the entities 510a and 520a based on their masks 510b and 520b. In this embodiment, both entities 510a and 520a may be categorized as mid-sized vehicles (step 304).

In FIG. 5C, the masks 510b and 520b are projected onto the BEV plane to generate projected masks 510c and 520c (step 306). In this embodiment, four perception cameras are mounted on the vehicle. The four perception cameras are projected onto the BEV plane, and are shown as reference points PC1 to PC4 in FIG. 5C. Since the image frame IM is generated by the perception camera represented by the reference point PC1, the masks 510b and 520b are projected onto the BEV plane using the camera pose CP of the perception camera represented by the reference point PC1. That is, the projected masks 510c and 520c are generated by extending projection lines from the reference point PC1 on the BEV plane based on the camera pose CP.

The BEV plane is a plane of a global coordinate system associated with the vehicle. Specifically, the processing device 220 determines a spatial transformation from a camera coordinate system of the perception camera to the global coordinate system based on the camera pose CP. Subsequently, the processing device 220 defines the BEV plane based on the spatial transformation. In an embodiment, the perception camera that generates the image frame IM as shown in FIG. 5A serves as the center (or the origin) of the BEV plane. In an embodiment, the BEV plane is defined as the ground plane of the global coordinate system.

For clarity, in FIG. 5D, only the reference point PC1 (which represents the perception camera used in this embodiment) and the frontal-facing edge 530 (which is the main target of this embodiment) are shown. It should be noted that the black line in FIG. 5D is the boundary contour of the front-facing edge 530. The boundary contour of the front-facing edge 530 can be extracted using multiple methods. One of the methods is to extend the front-facing edge 530 for one pixel and generate another image. That is, the newly generated image will have a larger front-facing edge. Then, a subtraction is made between the two images. As a result, the remaining pixels of the larger front-facing edge form the boundary contour of the front-facing edge 530 (step 308).

FIGS. 6A and 6B show a procedure for obtaining a set of frontal pixels 620 of the front-facing edge 530 according to embodiments of the present disclosure. The orientations of the entities 510a and 520a are required for object localization. Therefore, it is necessary to identify the portion of the front-facing edge 530 that represents the sides of the entities 510a and 520a oriented toward the perception camera. Since the side orienting toward the perception camera has the minimum distance among all sides, the procedure described below is performed to identify such side.

After extracting the boundary contour of the front-facing edge 530, as shown in FIG. 6A, a plurality of dashed lines (only dashed lines 610a and 610b are shown) are extended from the reference point PC1. Each of the dashed lines is connected between the reference point PC1 and a pixel of the boundary contour. The processing device 220 calculates the slope of each dashed line and the distance between each pixel and the reference point PC1. For pixels along dashed lines having the same slope, the pixel with the minimum distance is selected (step 402).

For example, referring to FIG. 6A, both pixels 600a and 600b are located along the dashed line 610a, and both pixels 600c and 600d are located along the dashed line 610b. Compared with their respective counterparts, pixels 600b and 600d, pixels 600a and 600c are closer to the reference point PC1. Therefore, pixels 600a and 600c are selected. After repeating the above procedure for every dashed line, as shown in FIG. 6B, a set of frontal pixels 620 is selected, including the pixels 600a and 600c.

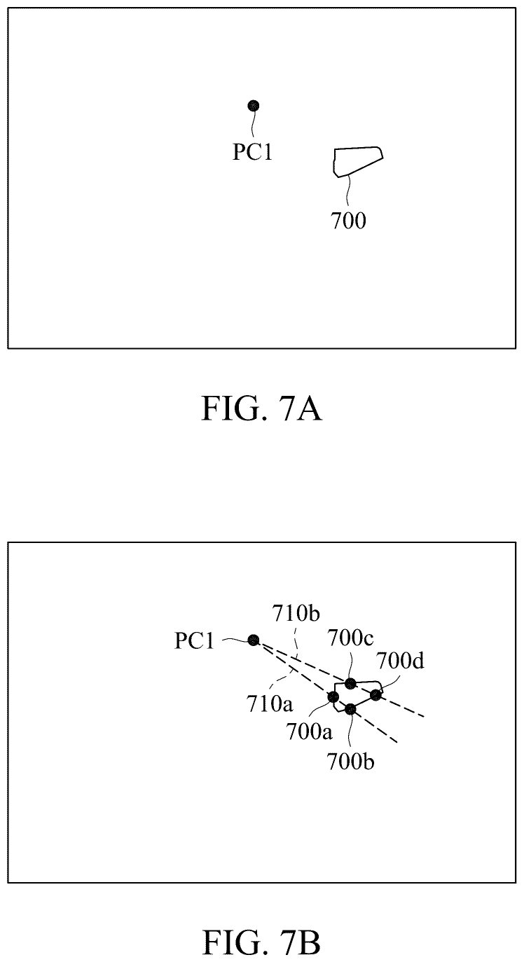

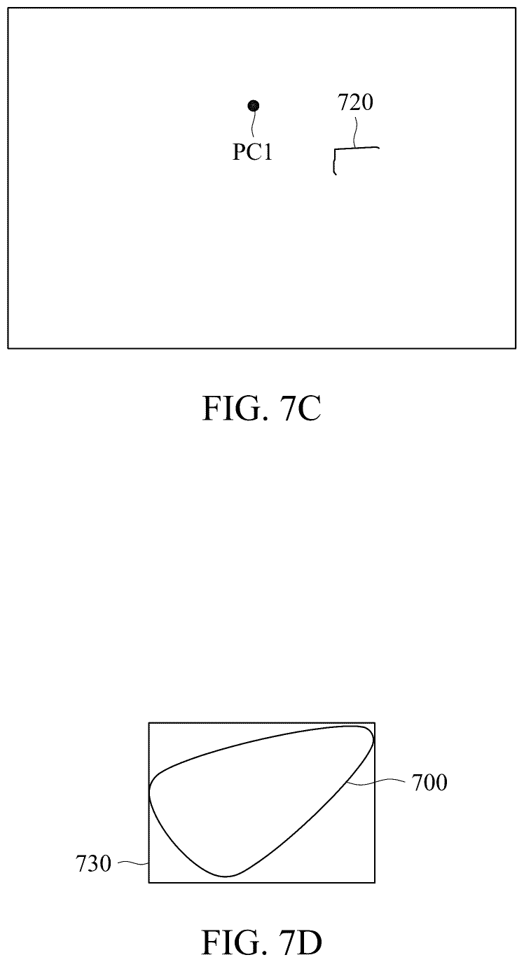

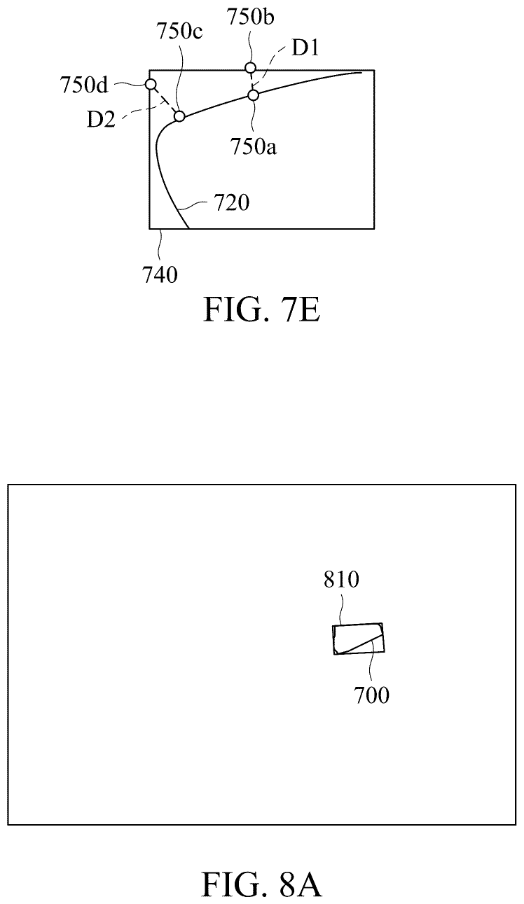

FIGS. 7A to 7E show a procedure for obtaining an optimum rectangle 740 according to embodiments of the present disclosure. In FIG. 7A, a convex hull 700 is generated based on the frontal pixels 620 shown in FIG. 6B (step 404). Specifically, the convex hull 700 is the smallest convex polygon that encloses all frontal pixels 620. Various methods may be used to generate the convex hull based on a set of points, such as Graham scan, Quickhull, or Divide-and-Conquer algorithms, but the present disclosure is not limited thereto.

Similar to the procedure used to identify the side of an entity oriented toward the perception camera, a plurality of dashed lines (only dashed lines 710a and 710b are shown) are extended from the reference point PC1, as shown in FIG. 7B. Each of the dashed lines is connected between the reference point PC1 and a pixel of the convex hull 700. The processing device 220 calculates the slope of each dashed line and the distance between each pixel and the reference point PC1. For pixels along dashed lines having the same slope, the pixel with the minimum distance is selected (step 406).

For example, referring to FIG. 7B, pixels 700a and 700b are located along the dashed line 710a, while pixels 700c and 700d are located along the dashed line 710b. Compared with their respective counterparts, pixels 700b and 700d, pixels 700a and 700c are closer to the reference point PC1. Therefore, pixels 700a and 700c are selected. After repeating the above procedure for every dashed line, as shown in FIG. 7C, a frontal edge 720 of the convex hull 700 is identified. Through the two procedures for identifying the side of the entity 510a that is oriented toward the perception camera, a more accurate orientation of the entity 510a can be determined, thereby improving the accuracy of the object localization.

The orientation of the entity 510a is determined after the frontal edge 720 is generated. The processing device 220 then proceeds to reconstruct the form of the entity 510a using a rotated rectangle method. FIG. 7D shows a candidate rectangle 730 fitted to enclose the convex hull 700. However, there may be multiple candidate rectangles that can be fitted to enclose the convex hull 700. To select the desired candidate rectangle, the processing device 220 uses the frontal edge 720 instead of the convex hull 700, as shown in FIG. 7E.

The frontal edge 720 includes a plurality of pixels, and there exists a minimum distance between a particular point of a candidate rectangle 740 and each pixel of the frontal edge 720. For example, as shown in FIG. 7E, a minimum distance D1 exists between a point 750b among all other points of the candidate rectangle 740 and a pixel 750a of the frontal edge 720. A minimum distance D2 exists between a point 750d among all other points of the candidate rectangle 740 and a pixel 750b of the frontal edge 720. After determining all minimum distances between the pixels of the frontal edge 720 and the corresponding points of the candidate rectangle 740, the processing device 220 calculates a total distance by summing these minimum distances. The candidate rectangle with the lowest total distance is considered the best fit and is selected as the optimum rectangle (step 408).

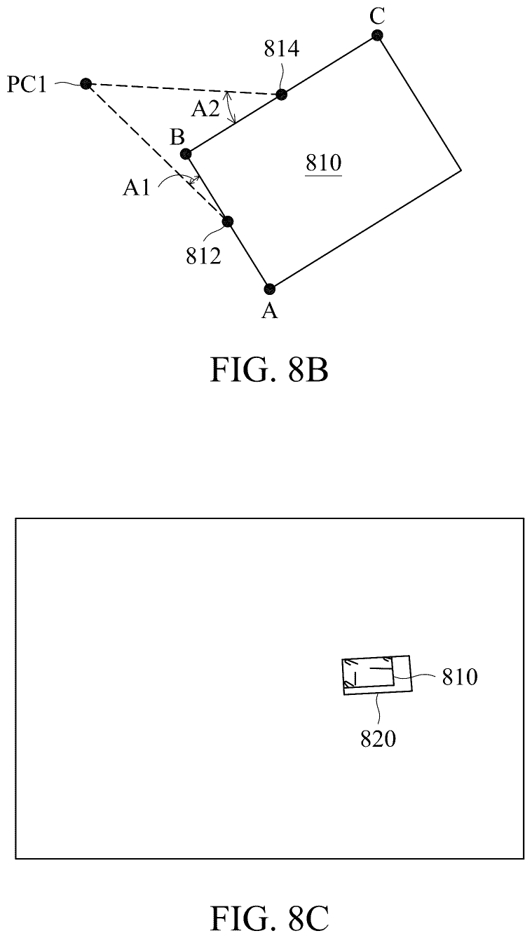

FIGS. 8A to 8C show a procedure for generating a resized rectangle 820 according to embodiments of the present disclosure. FIG. 8A shows the convex hull 700 and an optimum rectangle 810. After the optimum rectangle 810 is selected, the processing device 220 proceeds to resize the optimum rectangle 810 to determine a reference location of the entity 510a (steps 310 and 410).

As mentioned above, the accuracy of object localization is affected by the orientation of the entity. Therefore, during resizing, the front side of the entity 510a is determined. In this embodiment, the category CT of the entity 510a is determined as a mid-sized vehicle, indicating that the front side of the entity 510a is the short side. Referring to FIG. 8B, the optimum rectangle 810 has a short side AB and a long side BC facing toward the reference point PC1. Points 812 and 814 are the midpoints of the short side AB and the long side BC, respectively. Two dashed lines are extended from the reference point PC1 to the midpoints 812 and 814, respectively. As a result, an angle A1 is formed between one of the dashed lines and the short side AB, while an angle A2 is formed between the other dashed line and the long side BC.

As shown in FIG. 8B, the angle A2 is larger than the angle A1. This indicates that, compared with the short side AB, the long side BC is more oriented toward the perception camera. Then, in FIG. 8C, a resized rectangle 820 is obtained based on the optimum rectangle 810 and the category CT of the entity 510a. In this embodiment, the long side BC is selected as the critical side of the optimum rectangle 810.

For example, the category CT of the entity 510a is a mid-size vehicle, which corresponds to a resized rectangle with a predetermined size. Then, the processing device 220 compares the short side and the long side of the resized rectangle with the critical side of the optimum rectangle 810. As shown in FIG. 8C, the long side of the resized rectangle 820 is more related to the critical side (i.e., the long side BC) of the optimum rectangle 810. That is, compared to the short side of the resized rectangle 820, the long side of the resized rectangle 820 is closer to the critical side (i.e., the long side BC) of the optimum rectangle 810 in length. Therefore, the long side of the resized rectangle 820 is configured to be aligned with the long side BC of the optimum rectangle 810.

The resized rectangle 820 includes a plurality of sets of coordinates representing the entity 510a on the BEV plane. These sets of coordinates (i.e., the reference location) are configured to generate the measured location ML of the entity 510a. For example, the coordinates of the center of the resized rectangle 820 may be selected as the reference location. In another embodiment, the coordinates of the four corners of the resized rectangle 820 may be selected as the reference location. In yet another embodiment, the entire resized rectangle 820 may be selected as the reference location. That is, at least one set of coordinates included in the resized rectangle 820 may be selected to generate the measured location ML of the entity 510a.

The above procedures present methods for object localization of the surrounding entities. Since the self-propelled apparatus 10 and/or the surrounding entities 22, 24, 26, and 28 (as shown in FIG. 1) may be moving, the relative direction and speed are important parameters for driving safety. Therefore, a method for trajectory prediction is provided herein based on the aforementioned object localization methods.

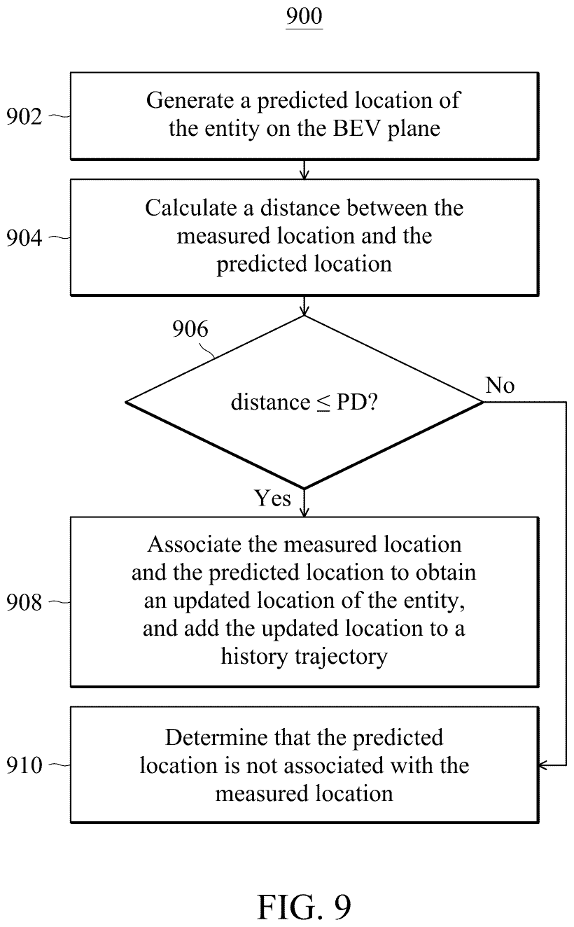

FIG. 9 shows a method 900 for tracking and predicting entity locations according to embodiments of the present disclosure. While the self-propelled apparatus 10 is moving, the processing device 220 measures the location of each surrounding entity at predetermined time intervals. These measured locations of the entities are stored in memory 224 in FIG. 2 as the historical trajectory HT of each entity. Then, at step 902, based on the respective historical trajectory HT, the processing device 220 generates a predicted location PL of each entity. Concurrently, the processing device 220 measures the current location of each entity. At step 904, the processing device 220 calculates a distance between the predicted location PL and the measured location ML.

At step 906, in response to the distance exceeding a predefined distance PD, the processing device 220 determines that the predicted location PL is not associated with the measured location (step 910). As a result, the predicted location PL will not be added to the historical trajectory HT. If the distance between the predicted location PL and the measured location ML does not exceed the predefined distance PD, the processing device 220 determines that the predicted location PL is associated with the measured location ML (step 908). As a result, the predicted location PL is added to the historical trajectory HT and is used to generate the following predicted locations.

The measured locations are used as a correction when generating the predicted locations to improve the accuracy of trajectory prediction. Through method 900, the processing device 220 can generate predicted locations that are highly associated with the measured locations (i.e., the actual locations) of the entity.

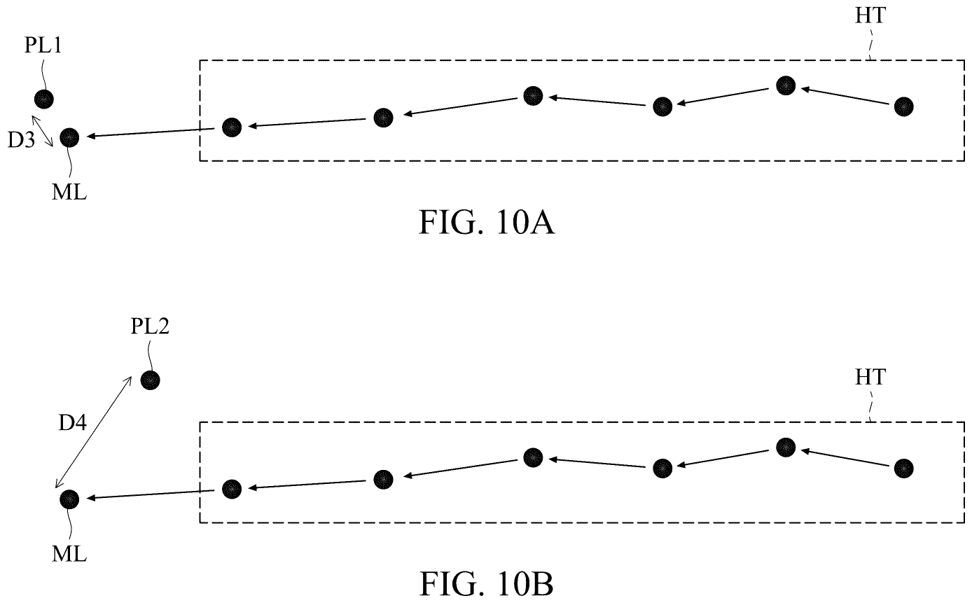

FIGS. 10A and 10B show the historical trajectories HT of the entity 510a with different predicted locations according to embodiments of the present disclosure. The historical trajectories HT and the measured locations ML in FIGS. 10A and 10B are the same. However, the processing device 220 generates different predicted locations, PL1 and PL2, in FIGS. 10A and 10B, respectively. The measured location ML in FIGS. 10A and 10B are the current locations (i.e., the object location of the current timestamp) of an entity, and the historical trajectory HT represents the previous measured locations ML of the entity. The processing device 220 generates the predicted locations PL1 and PL2 based on the historical trajectory HT (step 902). The processing device 220 then calculates a distance D3 between the predicted location PL1 and the measured location ML, and a distance D4 between the predicted location PL2 and the measured location ML.

It is assumed that the distance D3 is less than the predefined distance PD, while the distance D4 exceeds the predefined distance PD. As a result, the predicted location PL1 is associated with the measured location ML, whereas the predicted location PL2 is not associated with the measured location ML. Accordingly, the processing device 220 only adds the predicted location PL1 to the historical trajectory HT.

The above embodiments describe the methods and procedures of the present disclosure using a single perception camera. However, methods and procedures provided herein may also be implemented using multiple perception cameras. For example, referring to perception cameras 12 and 14 in FIG. 1, each of them generates and outputs one image frame IM to the processing device 220. Then, methods 300 and 400 are performed to process each of the image frames IM and generate the reference locations of the surrounding entities.

In this embodiment, each of the perception cameras 12 and 14 generates one reference location of an entity. In consideration of errors in the camera pose CP of the perception cameras 12 and 14, the two reference locations may not coincide. Therefore, the processing device 220 determines whether the two reference locations satisfy a criterion. Specifically, the criterion includes that the two reference locations are within a preset distance (which may differ from the predefined distance PD). If the criterion is satisfied, the processing device 220 merges the two reference locations (e.g., determines a mid-location as the reference location of the entity). If the criterion is not satisfied, the processing device 220 performs methods 300 and 400 again to determine a new reference location of the entity.

The present disclosure provides methods, procedures, and systems for object localization and trajectory prediction of surrounding entities of a self-propelled apparatus. Compared with methods using a bounding box, the disclosed approaches improve the accuracy by using instance segmentation. Additionally, compared with end-to-end deep learning methods, the disclosed approaches reduce complexity by using a combination of simple image processing techniques.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An object localization system, comprising:
a processing device;
a perception camera coupled to the processing device and mounted on a self-propelled apparatus, wherein the perception camera is configured to generate an image frame; and
a memory, comprising a computer-readable code executable by the processing device to:
generate a mask of an entity within the image frame and determine a category of the entity by using an instance segmentation model;
project the mask onto a bird-eye-view (BEV) plane of a global coordinate system associated with the self-propelled apparatus to generate a projected mask;
identify a front-facing edge of the projected mask relative to the perception camera on the BEV plane;
determine a reference location corresponding to the front-facing edge, wherein the reference location comprises at least one set of coordinates representing the entity on the BEV plane; and
generate a measured location of the entity on the BEV plane based on the reference location and the category of the entity.

2. The object localization system as claimed in claim 1, wherein the memory stores a camera pose of the perception camera associated with the self-propelled apparatus, and the computer-readable code is executable by the processing device to determine a spatial transformation from a camera coordinate system of the perception camera to the global coordinate system based on the camera pose, and to define the BEV plane according to the spatial transformation.

3. The object localization system as claimed in claim 2, wherein the computer-readable code is executable by the processing device to:
project the mask onto the BEV plane of the global coordinate system by extending projection lines from a reference point on the BEV plane based on the camera pose.

4. The object localization system as claimed in claim 3, wherein the reference point on the BEV plane corresponds to a projected position of the perception camera on the BEV plane.

5. The object localization system as claimed in claim 2, wherein the camera pose includes extrinsic parameters and intrinsic parameters of the perception camera, and wherein the extrinsic parameter includes a height information, a horizontal position, and an orientation information of the perception camera relative to the global coordinate system.

6. The object localization system as claimed in claim 1, wherein the computer-readable code is executable by the processing device to identify the front-facing edge by extracting a boundary contour of the projected mask on the BEV plane.

7. The object localization system as claimed in claim 6, wherein the computer-readable code is executable by the processing device to:
identify a set of frontal pixels of the boundary contour of the projected mask, wherein the set of frontal pixels is located on a side of the projected mask facing a reference point on the BEV plane;
select, from a plurality of candidate rectangles fitted to enclose the frontal pixels, an optimum rectangle based on distances between the set of frontal pixels and each of the candidate rectangles;
resize the optimum rectangle, based on the category of the entity, to obtain a resized rectangle representing the entity on the BEV plane; and
generate the reference location based on the resized rectangle.

8. The object localization system as claimed in claim 7, wherein the operation of selecting the optimum rectangle from the candidate rectangles further comprises:
generating a convex hull based on the set of frontal pixels;
identifying a frontal edge of the convex hull, wherein the frontal edge is located on a side of the convex hull facing the reference point on the BEV plane; and
determining the optimum rectangle from the candidate rectangles fitted to enclose the convex hull based on the distances between each of the candidate rectangles and the frontal edge.

9. The object localization system as claimed in claim 1, further comprising:
another perception camera, configured to synchronously generate, together with the perception camera, a first wide-view image and a second wide-view image having an overlapping field of view,
wherein the computer-readable code is executable by the processing device to:
generate a first mask and a second mask of the entity within the first wide-view image and the second wide-view image, respectively, and to determine the category of the entity, by using the instance segmentation model;
project the first mask and the second mask onto the BEV plane of the global coordinate system associated with the self-propelled apparatus to generate a first projected mask and a second projected mask;
identify a first front-facing edge of the first projected mask relative to the perception camera, and a second front-facing edge of the second projected mask relative to the another perception camera on the BEV plane;
determine a first reference location corresponding to the first front-facing edge and a second reference location corresponding to the second front-facing edge, wherein each of the first reference location and the second reference location comprises the at least one set of coordinates representing the entity on the BEV plane; and
generate the measured location of the entity at a current timestamp by merging the first reference location and the second reference location in response to the first reference location and the second reference location satisfying a first predefined criterion.

10. The object localization system as claimed in claim 9, wherein the first predefined criterion comprises that the first reference location and the second reference location are within a first predefined distance on the BEV plane.

11. The object localization system as claimed in claim 1, wherein the memory further stores a historical trajectory including a previous location of the entity on the BEV plane, and wherein the computer-readable code is executable by the processing device to:
generate a predicted location on the BEV plane based on the historical trajectory;
calculate a distance between the measured location and the predicted location; and
associate the measured location with the predicted location to obtain an updated location of the entity on the BEV plane in response to the distance between the measured location and the predicted location satisfying a second predefined criterion.

12. The object localization system as claimed in claim 11, wherein the second predefined criterion comprises that the distance between the measured location and the predicted location is within a second predefined distance on the BEV plane.

13. The object localization system as claimed in claim 1, wherein the BEV plane is defined as a ground plane of the global coordinate system.

14. The object localization system as claimed in claim 1, wherein the perception camera is a fisheye camera.

15. A method for object localization, executed by a processing device, the method comprising:
generating an image frame by a perception camera mounted on a self-propelled apparatus;
generating a mask of an entity within the image frame and determining a category of the entity using an instance segmentation model;
projecting the mask onto a bird-eye-view (BEV) plane of a global coordinate system associated with the self-propelled apparatus to generate a projected mask;
identifying a front-facing edge of the projected mask relative to the perception camera on the BEV plane;
determining a reference location corresponding to the front-facing edge, wherein the reference location comprises at least one set of coordinates representing the entity on the BEV plane; and
generating a measured location of the entity on the BEV plane based on the reference location and the category of the entity.

16. The method for object localization as claimed in claim 15, wherein the operation of projecting the mask onto the BEV plane of the global coordinate system further comprises:
determining a spatial transformation from a camera coordinate system of the perception camera to the global coordinate system based on a camera pose, and defining the BEV plane according to the spatial transformation.

17. The method for object localization as claimed in claim 16, further comprising:
projecting the mask onto the BEV plane of the global coordinate system by extending projection lines from a reference point on the BEV plane based on the camera pose.

18. The method for object localization as claimed in claim 17, wherein the reference point on the BEV plane corresponds to a projected position of the perception camera on the BEV plane.

19. The method for object localization as claimed in claim 16, wherein the camera pose includes extrinsic parameters and intrinsic parameters of the perception camera, and wherein the extrinsic parameter includes a height information, a horizontal position, and an orientation information of the perception camera relative to the global coordinate system.

20. The method for object localization as claimed in claim 15, wherein the operation of identifying a front-facing edge of the projected mask relative to the perception camera on the BEV plane further comprises:
identifying the front-facing edge by extracting a boundary contour of the projected mask on the BEV plane.

21. The method for object localization as claimed in claim 20, wherein the operation of determining the reference location corresponding to the front-facing edge further comprises:
identifying a set of frontal pixels of the boundary contour of the projected mask, wherein the set of frontal pixels is located on a side of the projected mask facing a reference point on the BEV plane;
selecting, from a plurality of candidate rectangles fitted to enclose the frontal pixels, an optimum rectangle based on distances between the set of frontal pixels and each of the candidate rectangles;
resizing the optimum rectangle, based on the category of the entity, to obtain a resized rectangle representing the entity on the BEV plane; and
generating the reference location based on the resized rectangle.

22. The method for object localization as claimed in claim 21, wherein the operation of selecting the optimum rectangle from the candidate rectangles further comprises:
generating a convex hull based on the set of frontal pixels;
identifying a frontal edge of the convex hull, wherein the frontal edge is located on a side of the convex hull facing the reference point on the BEV plane; and
determining the optimum rectangle from the candidate rectangles fitted to enclose the convex hull based on the distances between each of the candidate rectangles and the frontal edge.

23. The method for object localization as claimed in claim 15, further comprising:
synchronously generating, with another perception camera together with the perception camera, a first wide-view image and a second wide-view image having an overlapping field of view;
generating a first mask and a second mask of the entity within the first wide-view image and the second wide-view image, respectively, and determining the category of the entity, by using the instance segmentation model;
projecting the first mask and the second mask onto the BEV plane of the global coordinate system associated with the self-propelled apparatus to generate a first projected mask and a second projected mask;
identifying a first front-facing edge of the first projected mask relative to the perception camera, and a second front-facing edge of the second projected mask relative to the another perception camera on the BEV plane;
determining a first reference location corresponding to the first front-facing edge and a second reference location corresponding to the second front-facing edge, wherein each of the first reference location and the second reference location comprises the at least one set of coordinates representing the entity on the BEV plane; and
generating the measured location of the entity at a current timestamp by merging the first reference location and the second reference location in response to the first reference location and the second reference location satisfying a first predefined criterion.

24. The method for object localization as claimed in claim 23, wherein the first predefined criterion comprises that the first reference location and the second reference location are within a first predefined distance on the BEV plane.

25. The method for object localization as claimed in claim 15, further comprising:
generating a predicted location on the BEV plane based on a historical trajectory of the entity;
calculating a distance between the measured location and the predicted location; and
associating the measured location with the predicted location to obtain an updated location of the entity on the BEV plane in response to the distance between the measured location and the predicted location satisfying a second predefined criterion.

26. The method for object localization as claimed in claim 25, wherein the second predefined criterion comprises that the distance between the measured location and the predicted location is within a second predefined distance on the BEV plane.
